(19) United States
(12) Patent Application Publication
(10) Pub. No.: US 2025/0200399 A1
(43) Pub. Date: Jun. 19, 2025

(54) METHODS AND SYSTEMS FOR GENERATIVE QUESTION ANSWERING FOR CONSTRUCTION PROJECT DATA

(71) Applicant: Trunk Tools, Inc., New York, NY (US)

(72) Inventors: Moritz Pascal Stephan, Stanford, CA (US); Robert Michael Balousek, Brooklyn, NY (US); Sarah Buchner, New York, NY (US); Christopher James Belsole, New York, NY (US)

(21) Appl. No.: 19/061,677

(22) Filed: Feb. 24, 2025

Related U.S. Application Data
(63) Continuation of application No. 18/796,141, filed on Aug. 6, 2024.
(60) Provisional application No. 63/660,871, filed on Jun. 17, 2024.
(60) Provisional application No. 63/517,948, filed on Aug. 7, 2023.

(51) Int. Cl. G06N 5/04

(52) U.S. Cl. CPC G06N 5/04

(57) ABSTRACT

The present disclosure provides methods and systems for generative question answering for construction project document. The method comprises: receiving a question from a user via a message interface, wherein the question is related to information from a plurality of construction project documents; identifying, using one or more large language models, one or more relevant documents from the plurality of construction project documents and one or more chunks relevant to the question, and generating an answer based at least in part on the one or more relevant documents and one or more chunks; and providing the answer and one or more links to the one or more relevant documents in a text message in the message interface.

### CROSS-REFERENCE

This application is a continuation of U.S. Utility application Ser. No. 18/796,141, filed Aug. 6, 2024, which claims the benefit of U.S. Provisional Application No. 63/517,948, filed Aug. 7, 2023, and U.S. Provisional Application No. 63/660,871, filed Jun. 17, 2024 which are incorporated herein by reference in their entirety.

### BACKGROUND

For any large commercial construction project larger than $10 million, any tiny detail is described somewhere in a document. Users or entities such as a superintendent, a project owner, or foreman may need information from such large volume of construction project data such as to decide which material to buy or how to direct the laborers. The information may be based on any piece of information from the type of coating to use for a railing to the pounds per square inch (PSI) requirements for the reinforced concrete foundation, Specifications, submittals, Requests for Information (RFIs), change orders, blueprints, which is contained in various construction project documents and data.

There have been methods and platforms for document processing, information retrieval and data management. For instance, data extraction or information extraction methods may be utilized to extract structured data from unstructured or semi-structured electronic document text, then a user may be allowed to search the data in the document such as based on a keyword match. However, current document data extraction and retrieval methods may require manual or handcrafted rules in the workflows without automation. Additionally, existing methods may lack the capability of insight querying with sufficient accuracy and can be time consuming.

### SUMMARY

The present disclosure provides systems and methods that allow large volume of construction project data/files (e.g., thousands of pages) to be searchable with reduced time and improved accuracy. In particular, systems herein may beneficially allow users to query any piece of information via a messaging interface by inputting a question in natural language. The system may generate answers to the user question along with one or more sources retrieved from the construction project data to ensure accuracy of the answer. For example, a user on-site may text a question via a messaging interface and receive an answer with one or more links to the relevant document sections within seconds. The instant question and answer user interface may beneficially enable the workforce to perform as if they had memorized every single project document, and save significant time on searching for answers. In some cases, a user can initiate an interaction with the system by sending a text message to a specified number. The user may initiate an interaction at any time by sending a text message to the specified number. In some cases, the system verifies that incoming messages come from phone numbers associated with valid users. This may enable the system to prevent abuse. In some cases, the system may provide a user with one or more follow up questions to clarify their request. The user may receive the one or more follow up questions via text message. In some case, the follow up question may ask the user questions regarding a type of document (e.g., RFI, contract, etc.,), a date range, or an acronym meaning, if the acronym used in the question can have multiple interpretations or is unknown. In some cases, the system may be configured to learn or save new acronyms. In some cases, the system may be configured to identify or determine acronyms based on context data or historical use data. In some cases, a user will receive an answer, and links to relevant sources via text message in response to their question. In some cases, the system may proactively send text messages to the user with updates about topics that the user previously inquired about. In some cases, the system may automatically send the user updates. In some cases, the user may request the system send an update. In some cases, a user may request the system to send an update according to a schedule or timer. In some cases, the system may proactively send text messages to the user informing them of important news on a construction site. In some cases, the users may receive a link to a web portal via text message where they can ask follow up questions and look at the actual sources. The users may interact with the systems directly via the web portal as well. In some cases, the system may send a user environmental updates for a location of one or more relevant constructions projects to the user. For example, the system may provide the user with weather updates for a location of a construction project or site the user is working on. In some cases, the system may provide the user with recommendation on how to minimize the impact of incoming weather changes. In some cases, the system may provide the user with analytics or projected impacts incoming weather may have on a construction project. For example, the system may predict delays and costs to a construction project related to incoming bad weather (e.g., heat waves, tornados, or rains storms). In some cases, the system may predict and/or analyze the impact of a construction mistake or delay on the cost of the project.

Systems and methods of the present disclosure may automate the workflows for transforming data trapped in large volume of construction project documents into insights thereby allowing users to perform insight querying (e.g., by asking question or query in natural language) with improved accuracy. In particular, the present disclosure provides an instant messaging interface for users to search through and ask questions of the construction-specific documents, and a backend system for extracting information (knowledge or insights) from the construction-specific document and data and retrieving the relevant information pertinent to the user's query along with sources of the answer/information to ensure accuracy.

Systems and methods herein may allow users to search through construction-specific documents by querying insights or ask intelligent questions. In some cases, the provided systems and methods may process construction-specific document types into a plurality of chunks with custom parsing methods. During a pre-processing stage, methods and systems herein may use recursive summarization methods such as utilizing large language models (LLMs) to generate a synopsis of each construction-specific document. The methods and systems herein may generate dense embeddings and sparse embeddings and store the embeddings for both the documents and the chunks.

During inference stage, methods and systems herein may identify documents that are relevant to the user's question and identify the most relevant pieces (e.g., passages, sentences) within each of those relevant documents and the most relevant pieces across all documents. Such relevant sources of construction data may form context which is then summarized and is fed into an LLM to answer the question. During the answer generation, systems and methods herein may use a unique prompt to the LLM to instruct the LLM to include citations of the relevant source documents to attribute specific source of content (e.g., passages, sections, chapters) to the answer.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows a method of preprocessing the construction-specific documents to build structured construction data.

FIG. 2 shows an exemplary method for the inference stage.

FIG. 3 shows examples of user interface for question-answer of construction project documents.

FIGS. 4A-4C show examples of user interfaces for document management and data ingestion.

FIGS. 5A-5B show an exemplary system workflow for generative question answering for construction project document.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The present disclosure provides methods, systems and platforms for construction project document and data processing, information and insight extraction and retrieval, and information query via instant messaging user interface. Methods and systems herein may allow large volume of construction project data/files (e.g., thousands of pages) to be searchable with reduced time and improved accuracy. In particular, systems herein may beneficially allow users to query any piece of information via a messaging interface by inputting a question in natural language. The system may generate answers to the user question along with one or more sources retrieved from the construction project data to ensure accuracy of the answer. For example, a user on-site may text a question via a messaging interface and receive an answer with one or more links to the relevant document sections within seconds. The instant question and answer user interface may beneficially enable the workforce to perform as if they had memorized every single project document, and save significant time on searching for answers.

The systems and platform herein may be capable of efficiently and effectively retrieving and extracting information from a universe of construction-specific documents (e.g., raw documents). The documents processed by the system herein may be construction-specific documents or construction project data. For instance, documents processed and searched by the system herein may include, but not limited to, Specifications, submittals, RFIs, change orders, blueprints, contracts, Orders, communication (e.g., Emails, Messages, etc.), and various other documents or data related to construction projection.

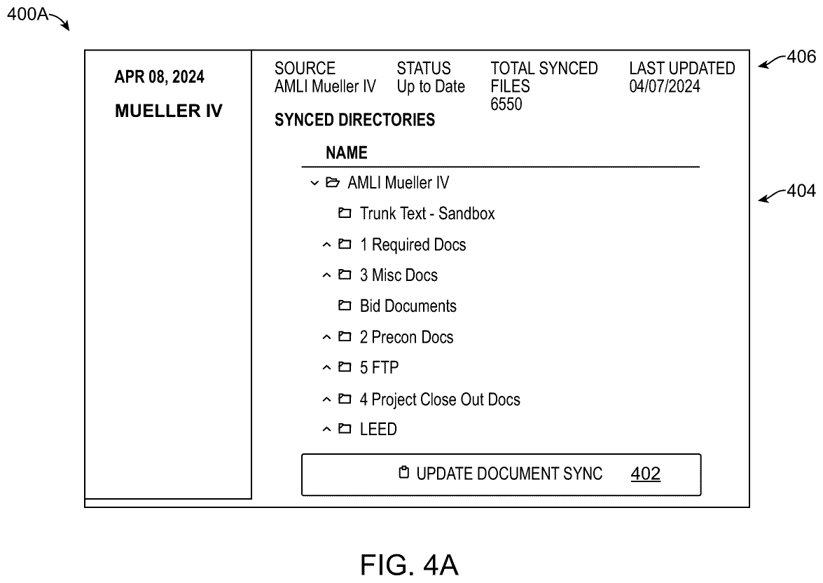

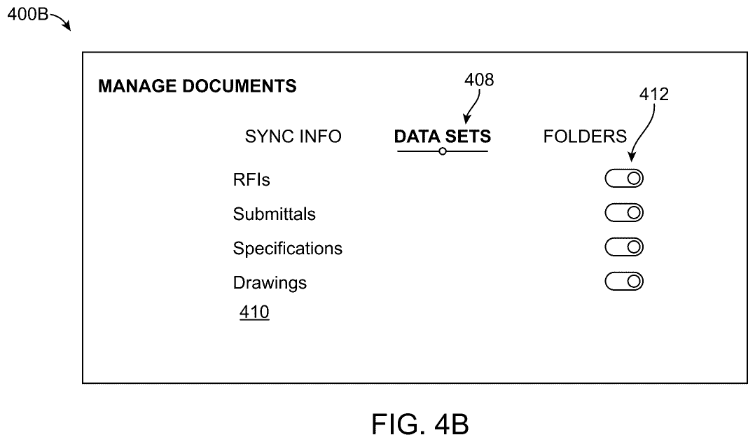

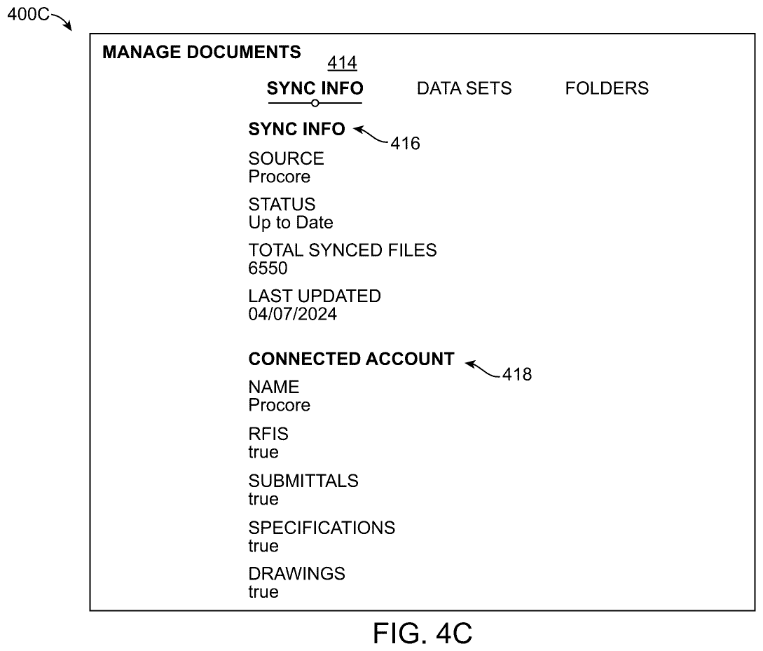

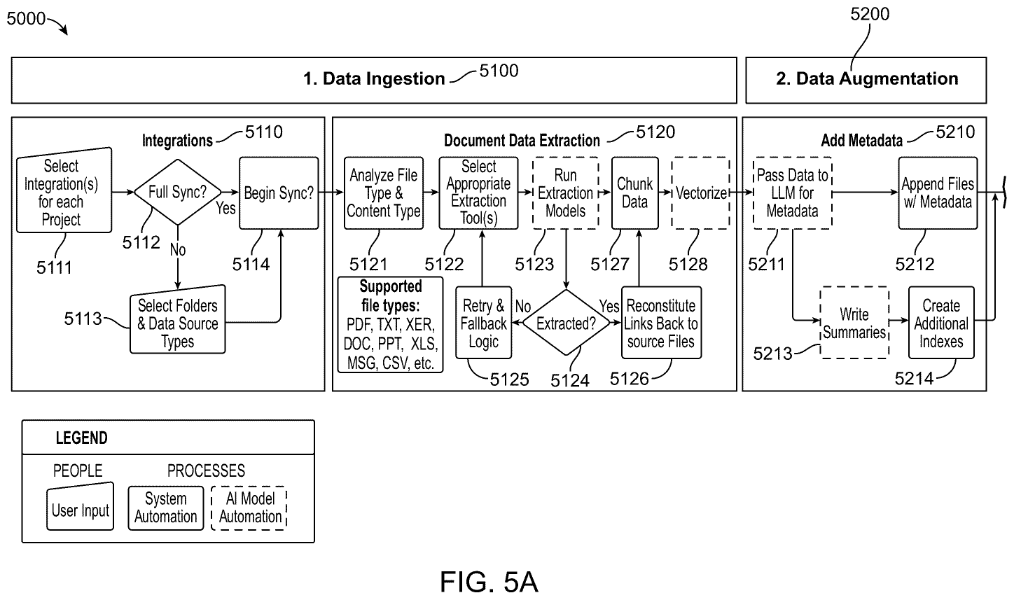

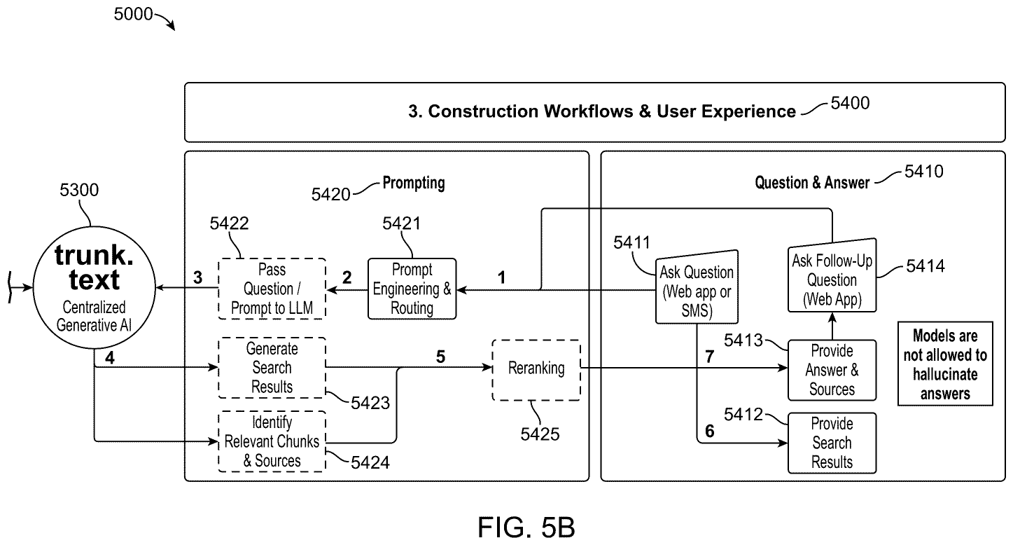

FIGS. 5A and 5B show an exemplary method 5000 for construction project document and data processing, information and insight extraction and retrieval, and information query via instant messaging user interface as described herein. The method 5000 comprises a data ingestion stage 5100. The data ingestion stage 5100 may comprise an integration stage 5110 and a document data extraction stage 5120. In some cases, the data integration stage 5110 may comprise presenting a user with a graphic user interface as illustrated in FIG. 4A. The user may select integration for one or more projects 5111 through the graphic user interface 400A. The graphic user interface 400A may have an update document sync button 402 configured to allow the user to update or initiate syncing for new documents. The graphic user interface 400A may display a synced directory list 404 showing the user all the folders and documents in a synced to a project. The graphic user interface 400A may comprise a status bar 406 illustrating the status of the synced documents. The sync status may include a time of the last update, a file count of the synced directory, a update status of the directory, and/or a directory file name. In some cases, the user may fully sync 5112 all documents for the project. In some cases, a user may only want to synch specific documents for project. In this case the user may select folders and/or data source types 5113 to sync to the project. In some cases, selecting folders and/or data source types 5113 to sync to the project may comprise presenting a user with a graphic user interface 400B as illustrated in FIG. 4B. In some cases, a user may navigate to a data set window 408 on the graphic user interface 400B. The user may select one or more document types 410 to be synced. The user may select one or more documents types by a toggling or pressing a switch or button 412 to turn on the sync for the selected document types 410. Once the necessary folders and documents are selected the system may automatically begin to synch 5114 the user's files. In some cases, a user may navigate to a sync info window 414 on a graphic user interface 400C as illustrated in FIG. 4C. In some cases, the sync info window 414 may comprise sync information 416. The sync information 414 may include but is not limited to, source information, status information, a synced file count, and a last sync update timestamp. In some cases, the sync info window 414 may comprise connected account information 418. The connected account information 418 may include but is not limited to, an account name, and a status for one or more document types uploaded through the account. In optional cases, the system may restrict access to one or more documents based on the user. For example, the system may restrict access to one or more documents based on the device or phone number that sent the question. In some questions, the system may restrict the LLM from linking one or more documents to the user's answer if they do not have access to the document used to generate the answer. In some cases, the system may notify the user that they do not have access to the necessary documents to answer the user's question. In some cases, the system may notify a supervisor or manager if a user has asked a question related to a restricted document. In some cases, a manager or supervisor may grant access one or more user's access to restricted documents. In some cases, the access can be for a specific time period. For example, a consultant or contracted worker may be granted access during the time they are working on a specific project. In some cases, the system may use location tracking of a user device to determine a user's access to documents. In some cases, the system may use tracking data from the user's device to provide context to the LLM regarding the user's question. The system may determine the project that a user is asking about based on tracking data and/or location data of the user device asking the question.

Once the user's files are synched, the document data extraction stage 5120 may begin. The document data extraction stage 5120 may comprise analyzing file types and content types 5121 from the synced folders and documents. After the files have been analyzed, the system may select one or more appropriate extraction tools 5122. In some cases, the one or more extraction tools provide one or more extraction models and or ML algorithms. Once the appropriate extraction tools are selected, the system may be configured to automatically run one or more extraction models 5123 and begin extracting 5124 relevant data from the synced files. In some cases, when the one or more extraction tools failed to extract relevant data, the system may retry 5125 and select new extraction tools. In some cases when the one or more extraction tools successfully extract relevant data, the system may reconstitute links back to the source files 5126 of the relevant extracting data. After the extracted data has been linked back to the source files, the method may perform one or more data chunking 5127 methods. In some cases, after data chunking the method comprises vectorizing 5128 the data chunks. In some cases, after the data charts and vectorized the method enters the data augmentation stage 5200. In some cases, the augmentation stage 5200 may comprise a metadata stage 5210. In some cases, the metadata stage 5210 may begin by passing data to one or more LLMs to extract metadata 5211 from the files. In some cases, the system may append the files with the metadata 5212 determined by the LLMs. In some cases, the metadata stage 5210 may comprise writing summaries 5213 based on the metadata determined by the LLMs. In some cases, the system may be configured to create additional indexes 5214 for the summaries. The appended files and indexed summaries are then delivered to a centralized generative AI platform 5300 configured for generating answers to the user question along with one or more sources retrieved from the construction project data to ensure accuracy of the answer.

In some cases, the method 5000, may comprise a construction workflow and user experience stage 5400. The construction workflow and user experience stage 5400 may comprise a question and answer stage 5410 and a prompting stage 5420. In some cases, the question and answer stage 5410 may comprise a user asking a construction related question 5411. The user may ask the question through a text message based platform. In some cases, the text message based platform may be a web application or a mobile application. In some cases, after a user asks a question 5411, the system is configured to utilize one or more prompt engineering techniques to generate an LLM 5421 prompt based on the user's question. The systems may then pass the user's question and generated LLM prompt 5422 to the centralized generative AI platform 5400. The centralized generative AI platform 5400 may generate search results 5423 based on the delivered the user's question and generated LLM prompt. The centralized generative AI platform 5400 may also identify relevant chunks and sources 5424 based on the delivered user's question and generated LLM prompt. The search results 5423 and relevant chunks and sources 5424 may be reranked 5425 and delivered to the user. In some cases, the centralized generative AI platform 5400 may deliver the ranked reach results 5412 to the user. In some cases, the centralized generative AI platform 5400 may deliver an answer to the user's question along with linked source data to the answer 5413. In some cases, a user may ask a follow up question 5414 based on the answer provided by the centralized generative AI platform 5400. In some cases, the centralized generative AI platform 5400 may prompt the user to ask a follow up question to help clarify what the user is wants.

The construction-specific documents and data can be any type of raw documents. In some cases, the raw documents may comprise unstructured or semi-structured electronic document text. Unstructured text documents may contain “free text” in which the underlying information is mainly captured in the words themselves. The unstructured document texts may include, for example, open text, and/or images, which have no predetermined organization or design. Semi-structured text may capture a significant portion of the information in the position, layout, and format of the text but the information within has no structure (e.g., tables). The documents may be, for example, PDF, raw text or html/DOCX representation and the like. The document data that are processed and searchable by the system may include text PDFs, scanned PDFs, spreadsheets, tables contained within PDFs, Word documents and the like. In some cases, documents such as PDF or image file may be converted to text data using OCR (Optical Character Recognition) techniques. In some cases, the systems and platforms described herein may be configured to use metadata to contextualize the content of the documents. In some cases, the document may comprise an image. The system may extract metadata to contextualize the image of the document and provide a description of the image. In some cases, the content of an image may not be searchable, but the description and context of the image may be searchable. In some cases, the system may provide a searchable reference to relevant document or image. The reference may allow user to search for document when the document itself does not contain any searchable material. In some cases, advance AI/ML techniques may be used to describe an image content. In some cases, the advanced AI/ML may be configured to automatically generate a description for an image.

In some cases, the systems herein may be capable of extracting information and retrieving insights from the raw documents by converting the raw document texts into structured data (e.g., document datasets, indexes, embeddings) then retrieving insight needed or desired by a user with machine learning techniques. The methods and systems herein may process the construction-specific document/data into smaller chunks using a custom parsing algorithm and generate dense embeddings and sparse embeddings and store the embeddings for both the documents and the chunks. In some case, the system is configured to use parsers for tables. In non-limiting examples, the system may use PDF Table Extraction and/or texts and layout extraction packages to extract tables and then parse the tables using the parser packages or using an LLM. In some cases, parsing methods are determined or adjusted based on a confidence level in the quality of a parsing. In some cases, the system may use an specialized parser configured to parse the special schedule format used in construction. The specialized parser may be configured to extract the actual and planned start and end dates of an activity in the schedule as well as the hierarchical dependencies between activities. In some cases, the specialized parse may be an “XER” parser.

As utilized herein, terms “component,” “system,” “interface,” “unit” and the like are intended to refer to a computer-related entity, hardware, software (e.g., in execution), algorithm, and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In some cases, a component can emulate an electronic component via a virtual machine, e.g., within a cloud computing system.

In some embodiments, methods and systems herein may provide various functions that can be implemented or accessed via web application program interfaces (APIs), a Software Development Kit (SDK), web-based integrated development environment (IDE) and the like. Various components of the system herein may be seamlessly integrated into a third-party platform or system via customized Software Development Kit (SDK) or APIs. For instance, intelligent information extraction and retrieval as well as document processing modules may be provided via open-ended integration with a full suite of APIs and plugins thereby allowing for convenient and seamless system integrations into any third-party systems.

The present disclosure also provides a user-friendly user interface (UI) which allows user to specify the information needed in natural language-based question and receive the answer instantly. In some cases, systems herein may beneficially allow users to query any piece of information via a messaging interface by inputting a question in natural language. The system may display answers to the user question along with one or more sources retrieved from the construction project data to ensure accuracy of the answer. For example, a user on-site may text a question via a messaging interface and receive an answer with one or more links to the relevant document sections within seconds. The instant question and answer user interface may beneficially improve flexibility for retrieving information embedded in large volume of construction documents and enable the workforce to perform as if they had memorized every single project document, and save significant time on searching for answers. In some cases, a user can initiate an interaction with the system by sending a text message to a specified number. The user may initiate an interaction at any time by sending a text message to the specified number. In some cases, the system verifies that incoming messages come from phone numbers associated with valid users. This may enable the system to prevent abuse. In some cases, the system may provide a user with one or more follow up questions to clarify their request. The user may receive the one or more follow up questions via text message. In some case, the follow up question may ask the user questions regarding a type of document (RFI, contract, . . . ), a date range, or an acronym meaning, if the acronym used in the question can have multiple interpretations or is unknown. In some cases, a user will receive an answer, and links to relevant sources via text message in response to their question. In some cases, the system may proactively send text messages to the user with updates about topics that the user previously inquired about. In some cases, the system automatically send the user updates. In some cases, the user may request the system send update. In some cases, a user may request the system send update according to a schedule or timer. In some cases, the system may proactively send text messages to the user informing them of important news on a construction site. In some cases, the users may receive a link to a web portal via text message where they can ask follow up questions and look at the actual sources. The users may interact with the systems directly via the web portal as well.

The output provided by the system may comprise an answer in response to the user input querying the information as well as one or more sources of the relevant content from the raw construction documents. The one or more sources may be presented in the form of citations of a list of source documents or citations of the relevant source passages/sections that are used by the LLM to generate the answer, as well as a link to drill down into the source documents. In some cases, a user may click on the link and be directed to another interface (e.g., a web page) to see the answer and a list of source documents. A user may select a source document, and the part of the answer that the document is used for may be highlighted, and the section of the document that the answer stemmed from may be highlighted. The system may highlight a word, short phrase or a span of texts that are attributed to the answer. The highlighted content from the raw document may include annotated relevant information (e.g., highlight, underline, or any visual indicator) that may or may not encompassing the answer directly.

In some cases, the system may use one or more tokenization methods to provide feedback data into an LLM. The system may tokenize the construction data when calling the OpenAI APIs to use one or more LLMs. In some cases, the OpenAI is configured to tokenize the data.

In some cases, the system may use one or more chunking techniques to split up text from one or more construction documents into semantically similar chunks that can then be embedded and use in search lookups. In some cases, chunking is done based at least in part on whether a piece of a document logically belongs together (e.g., separated by subheadings). In some cases, chunking is done based at least in part on a fixed chunk size with some chunk overlap for text that is too long. When the raw construction documents are processed by the system herein for data extraction, the document may be chunked and may be processed to build document datasets. In some cases, indexes are generated for the datasets. In some cases, the indexes may comprise sparse index each may index or correspond to an element such as a token, a chunk, a word, a passage, or other data structures for efficient lookup. It should be noted that any other suitable data structures may be used for the lookup of the elements. In some cases, the indexes may also comprise a dense index each may correspond to or index elements such as a representation of textual items (e.g., word embeddings of a chunk of texts). For example, a word embedding (a real-valued vector that encodes the meaning of the word such that the words that are closer in the vector space are expected to be similar in meaning) may be indexed and a dense index may be created. In some cases, sparse and dense indexing is utilized for all documents. The document dataset may transform the raw PDFs into parsed text which may then be converted into chunks. The chunks are then embedded and stored. A chunk may, for example, be a sentence, a section, a passage, a paragraph, a clause, or a sub-clause of a document. The chunks may be defined such that they correspond to the format of the document. For example, chunks may not carry over from one part of the document, such as a chapter or sub-chapter, to another or from one paragraph to another. In some cases, chunks of text may be terminated by a full stop. In some cases, at least some chunks may contain multiple words. In some embodiments, a representation of textual items may be indexed and a dense index may be created. For example, a dense index for a section may correspond to the representation or word embeddings of the section. The term “section” as utilized herein may be sentence-level, or longer sections (e.g., paragraphs). In some cases, the sparse index and dense index may be built for both the raw document and input query for information retrieval. The term “sparse index” and “dense index” may also be referred to as “sparse embedding” or “dense embedding” which are utilized intertangle throughout the specification. Details about building the sparse embedding and dense embedding are described later herein.

In some cases, an answer may comprise a string of text, generated by a generative Large Language Model (LLM). The LLM can be any suitable LLM. For instance, the LLM may be the standard next-word prediction model. In some cases, an answer may be generated by a generative LLM based on one or more source documents or source passages identified in response to a user's question. In some cases, the answer may be generated in natural language and displayed along with the one or more source documents or source passages. In some examples, the answer (generated answer) may be presented at the user interface (e.g., in a text message) along with a list of source documents that a user may conveniently visualize and verify the authenticity or authority of the generated answer by clicking on the links of the source documents displayed in the message and view the relevant content highlighted by the system.

In some cases, a question quality is determined for a user question. The question quality determination may be done using an LLM. The LLM may have some examples of what a “good” and “bad” question is. For example, a bad question is one that is inappropriate or underspecified (e.g., When asking about the status of the drywall, the system may decide to ask the user which floor they want to know the drywall status of).

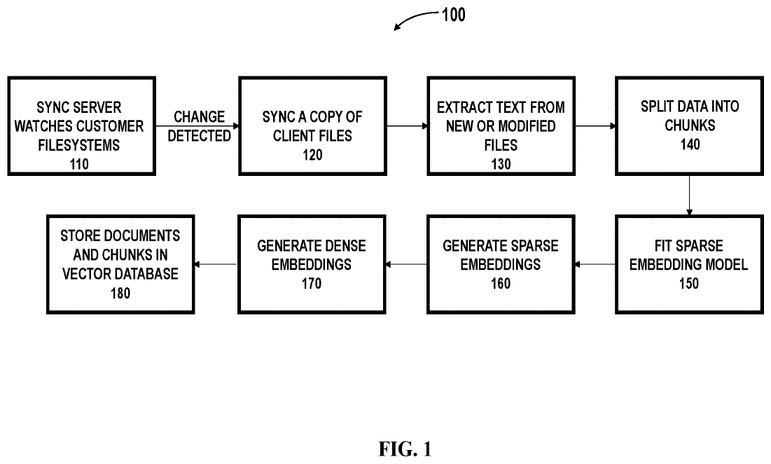

FIG. 1 shows a method 100 of preprocessing the construction-specific documents to build structured construction data. In the illustrated preprocessing method 100, the system herein may monitor changes in the construction filesystem 110. For example, a sync server may monitor and detect changes made to construction files/documents stored in a customer filesystems (e.g., Box, SharePoint, Procore, etc.). The customer Filesystems may be possessed by a customer entity and in communication with the system herein. Upon detection of the change, the system may sync a copy of the document stored in a repository or data store of the system 120. In some cases, copies of the documents are stored in cloud storage system (S3). In some cases, the embeddings and text chunks may be stored in a 3rd party vector database (e.g., pinecone). In some cases, the method may comprise implementing a system to periodically check the connected data sources of the customer and copy over and ingest any new documents. FIG. 4 illustrates an exemplary user interface 400 wherein a user may upload and manage their Filesystems. The user interface 400 may provide a user with an option to update a document synch 402. In some cases, the user interface 400 may be configured to display filenames and folders 404 of a Filesystems. The user interface 400 may be configured to display a status 406 of the users Filesystems. Next, the system may process the copy of the new or modified files document 130 to extract text data.

As described above, the construction-specific document or files may be any type of raw documents. In some cases, the raw documents may comprise unstructured or semi-structured electronic document text. Unstructured text documents may contain “free text” in which the underlying information is mainly captured in the words themselves. The unstructured document texts may include, for example, open text, images, which have no predetermined organization or design. Semi-structured text may capture a significant portion of the information in the position, layout, and format of the text but the information within has no structure (e.g., tables). The documents may be, for example, PDF, raw text or html/DOCX representation and the like. The document data that are processed and searchable by the system may include text PDFs, scanned PDFs, spreadsheets, tables contained within PDFs, Word documents and the like. In some cases, documents such as PDF or image file may be converted to text data using OCR (Optical Character Recognition) techniques.

In some cases, extracting text data from the files 130 may comprise multiple operations. In some cases, the method may first extract a document title across all document types using an LLM. For example, the prompt to the LLM for extracting the document title may include a piece of the beginning of the document as well as the file name and folder path. Next, the method may extract a datetime stamp utilizing the LLM. For example, the prompt to the LLM may include a slice of the document beginning, file metadata, and the filename. Exacting the datetime stamp beneficially identifies different versions of the same document.

The method may further determine document type such as whether a document is text-based, image-based, or table-based document. The method may utilize a custom algorithm to parse the document types. For instance, the parsing algorithm may first determine if the document is image-based document by determining whether the ratio between characters to pages is lower than a predetermined threshold. If the ratio is below the threshold, the document is image-based. Otherwise, the document is not image-based, and the algorithm may further determine whether it is table-based document by checking whether the ratio of numeric to alphabetical characters is greater than a predetermined threshold. If yes, then the document is table-based document otherwise it is text-based document.

If the document is image-based, OCR techniques may be employed to converted it to text data. If the document is a table-based document, the tables may be converted into a text by concatenating each cell value with the name of the corresponding cell and concatenating the values within a row and finally all the rows. For instance, for spreadsheets files and tables that are extracted from PDFs, the method may concatenate each non-empty value with the name of the corresponding column, then concatenate the values within each row using commas as delimiters, and finally concatenate all rows using double newlines as delimiters. For text-based documents, the method may utilize parsers built to preserve the structure of the particular document type (e.g., specification, submittal, etc.) if the document is already in the correct format. If the document is not in the correct format, the method may flatten the text.

The method may proceed with chunking the documents 140. A chunk may, for example, be a sentence, a section, a passage, a paragraph, a clause, or a sub-clause of a document. The chunks may be defined such that they correspond to the format of the document. In some cases, the method may chunk the document to a fixed size with overlap using double newlines as separators.

The method may then process the raw texts data/chunks by fitting a sparse embedding model 150 to the chunks and generate sparse embeddings 160. As an example, the sparse embeddings for each document may be generated using BM25. The sparse index may be used to determine the saliency of the word/term in a passage. For example, the sparse index may be computed based on a count of occurrences of a term in the portion of the passage and an inverse document frequency (IDF) weight. The IDF weight may represent how common or rare a word is across the sections in the corpus. For instance, the closer it is to 0, the more common a word is. In an example, the metric (IDF) may be calculated by taking the total number of sections, dividing it by the number of sections that contain a word, and calculating the logarithm. It should be noted that any other suitable methods can be utilized to calculate the IDF.

The method may also generate dense embeddings for each document. In some cases, the dense embeddings may be generated for each document summary using a pretrained embedding model. In some cases, the pretrained models are trained using real construction documents from historical and/or active construction projects. In some cases, the training data comprises already confirmed reference questions and answers. The reference answers may be generated by trusted or verified users. The summaries for each document may be generated using an LLM based on the extracted raw text. The dense embeddings may be used to retrieve the representation (semantic meaning) of a section, a chunk, or any other data structure. Each chunk or section may be indexed and may be retrieved by a dense embedding. As an example, a dense embedding may correspond to a dense representation of a passage/chunk such as a tensor of floats computed to capture the semantic meaning of the chunk. Any suitable metrics may be utilized for determining the semantic meaning of a chunk or passage.

The sparse and dense embeddings of all documents may be stored in a vector database along with metadata that references the original document and references to the chunks deriving from the document 180. The same embedding procedure may be applied for all chunks for any new files/documents and the embeddings may be stored in a vector database with references to the document they originate from.

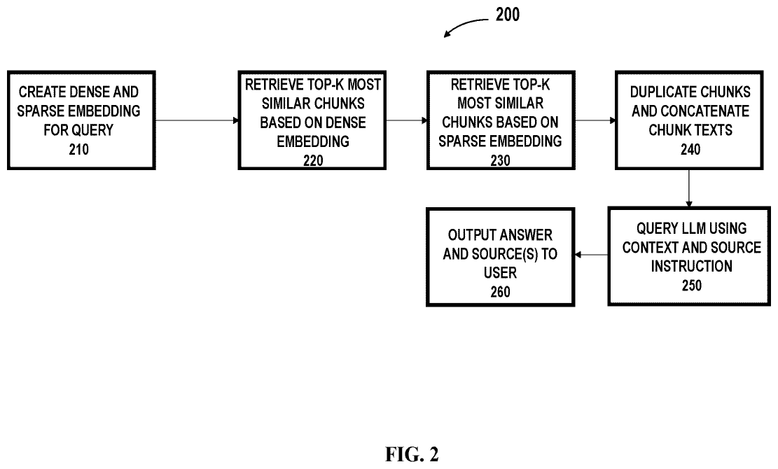

FIG. 2 shows an exemplary method 200 for the inference stage. During an inference stage when a user inputs a question to the system, the method 200 may first generate dense embeddings and sparse embeddings of the input question 210. The embedding method can be the same as the embedding method as described above. For example, the dense embeddings may be generated using a pre-trained embedding model and the sparse embedding may be generated using BM25.

Next, the method may identify the topmost relevant documents by finding the document embeddings that are most aligned with the vector using dot product similarity search. For example, the method may generate a prompt to an LLM including the filenames of all stored documents, the user question, and a query instruction asking the LLM to select all documents that may be relevant to search for the user question. In some cases, the method may further generate prompt to an LLM based on one or more of, a user question history, document summaries, document metadata, user location data, or a combination thereof. In some cases, the method comprises adjusting a construction focused LLM prompt template based on one or more of, a user question history, document summaries, document metadata, user location data, or a combination thereof. In some cases, the prompt to the LLM may further include instruction to the LLM to output which of the provided sources (e.g., chunks) it utilized in constructing the answer. The chunks outputted from the LLM may be utilized to determine which of the source documents to display to the user in the text message. For example, one or more source documents may be selected from a plurality of relevant source documents identified by the LLM based on the chunks. For instance, source documents are ranked based on the relevancy of the chunks identified in the documents) and the higher-ranked source documents may be displayed in the text message.

The method may combine the documents from the two relevancy searches (i.e., search for top-k most similar chunks based on sparse embeddings 230 and dense embeddings 220) and deduplicate them.

In some cases, the method may employ dot product similarity search to retrieve the top-k most relevant chunks within each document based on dense embeddings 220 and based on sparse embedding 230. The method may then concatenate the result. Alternatively, instead of conducting two relevancy searches, the method may use a hybrid embedding that is a convex combination of the dense embedding and sparse embedding controlled by a hyperparameter to perform a single relevancy search. In some cases, hyper parameter is “alpha” which controls the weighting between dense and sparse embedding. In some cases, the hybrid embedding is a convex combination, so alpha*sparse+(1-alpha)*dense. The value of alpha may be configured by measuring which alpha yields the highest retrieval precision and recall on a set of validation queries.

Next, the method may query the top-k most relevant chunks across all documents using dot product similarity search and deduplicate the resulting chunks. The process of searching the top-k most relevant chunks across all documents may adopt the same method for searching relevant chunks within each document. In some cases, the relevancy of a document type depends on the question. For example, for a schedule question, documents of type “schedule” may only be looked at since even if there is some information about the schedule in other documents, it is likely wrong since the schedule is the ultimate source of truth.

To generate the context for the question-answering, the method may concatenate the text of all selected chunks 240 including the chunks within each relevant document and chunks across all documents. Next, the method may generate context data utilizing the chunks by recursively summarizing the context until the output is fewer than a certain number of tokens (defined as a hyperparameter). In some cases, hyperparameters may include but are not limited to, a number of dense/sparse chunks retrieved; a number of queries made to the vector database; a maximum chunk size; or an alpha for the hybrid embeddings.

During summarization, the method may generate a prompt to the LLM wherein the prompt may include source instructions to the LLM. The instruction may be, for example, include citations in the output that refer to the chunks used for each piece of the summary in HTML style notation (i.e., <chunk_id_1, chunk_id_2> some text </chunk_id_1, chunk_id_2>). The method may prompt an LLM to answer the question and provide the summarized context (i.e., source instruction) 250. In some cases, the prompt may include other instruction such as the styles of the output. For instance, the method may prompt the LLM to include the HTML style citations. The final output comprising the answer, the list of sources in the instructed style may then be presented to a user 260.

The systems and methods herein may beneficially allow users to query any piece of information via a messaging interface by inputting a question in natural language. The system may receive user question via the messaging application and output the answer in the message application. For example, a user may send text message (SMS) to ask questions and may receive a text message containing the answer and a list of sources.

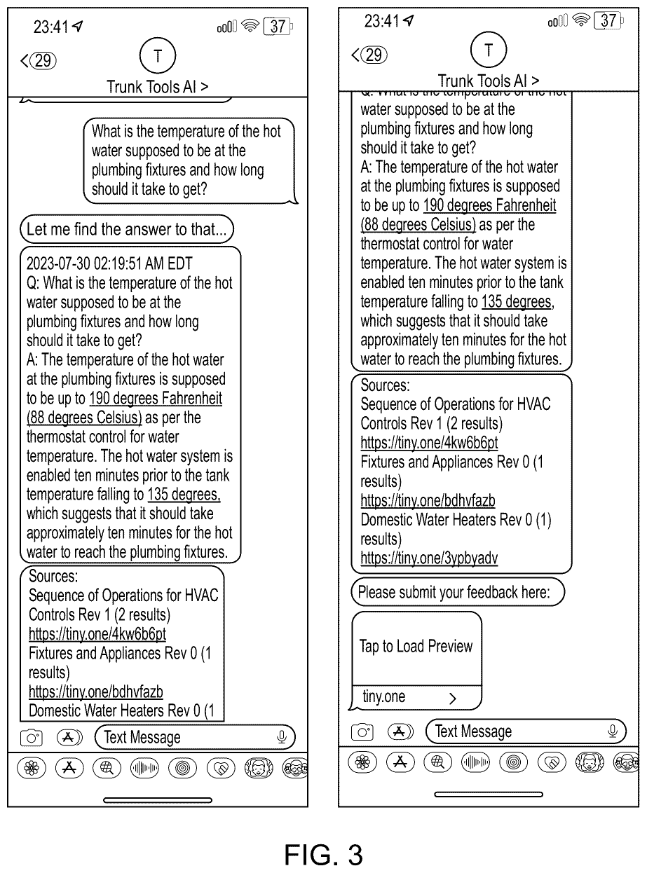

FIG. 3 shows examples of user interface for question-answer of construction project documents. As shown in the example, a user may send a question as text message to a specified number. The message application may optionally respond with a receipt confirmation and begin processing the question. The message interface may respond with a message containing the question, the answer, and a list of source documents used, as well as a link to drill down into the source documents. The user may click on the link and be directed to another interface (e.g., a web page) to see the answer and a list of source documents. A user may select a source document, and the part of the answer that the document is used for may be highlighted, and the section of the document that the answer stemmed from may be highlighted. The system may highlight a word, short phrase or a span of texts that are attributed to the answer. The highlighted content from the raw document may include annotated relevant information (e.g., highlight, underline, or any visual indicator) that may or may not encompassing the answer directly.

The system may allow users to view questions and answers in the past (e.g., log into a user account on a web site) or by viewing the past messages exchanged. The message interface may allow users to share answers with other users using a share button, which prompts them to put in the recipient's name same as sharing a text message.

In some embodiments, the system herein may comprise sockets to integrate the variety of LLM models and/or functional components. In some cases, for time-consuming or computational expensive models, a socket to a GPU API may be provided. Other less-computationally expensive processes may be implemented as parallel CPU processing steps. A socket may provide a programming construct, an instance, or instantiate, that can make use of suitable protocol to send and receive data. For example, a socket may be Web Socket APIs allow bi-directional, full-duplex communication between clients and servers. The API may not require a new connection to be set up for each message to be sent between clients and servers. Once the connection is set up the data can be sent and received continuously without any interruption. Sockets such as WebSocket APIs are suitable for Applications with low latency or high throughput requirements. Alternatively, or additionally, various functional components of the system herein may be seamlessly integrated into a third-party platform or on-premises environment via customized Software Development Kit (SDK).

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations, and equivalents.

What is claimed is:

1. A method for generative question answering for construction project documents, the method comprising:
(a) receiving a question from a user via a message interface, wherein the question is related to information from a plurality of construction project documents;
(b) generating a large language model (LLM) prompt based at least in part on the question;
(c) identifying, using one or more LLMs, one or more relevant documents from the plurality of construction project documents and one or more relevant chunks related to the question, and generating an answer based at least in part on the one or more relevant documents, the one or more relevant chunks, and the LLM prompt; and
(d) providing the answer and one or more links to the one or more relevant chunks used to generate the answer in a text message in the message interface.

2. The method of claim 1, further comprising processing the plurality of construction project documents into a plurality of chunks.

3. The method of claim 2, wherein the one or more relevant documents and the one or more relevant chunks are identified based on dense embeddings and sparse embeddings of the question and the plurality of chunks of the plurality of construction project documents.

4. The method of claim 3, wherein processing the plurality of construction project documents comprises applying a parsing algorithm to generate dense embeddings and sparse embeddings for the plurality of construction specific documents and the plurality of chunks.

5. The method of claim 2, wherein processing the plurality of construction project documents into the plurality of chunks comprises using one or more chunking techniques.

6. The method of claim 1, wherein the one or more relevant chunks comprise a word, multiple word, a sentence, a section, a passage, a paragraph, a clause, or a sub-clause.

7. The method of claim 1, wherein the one or more links direct the user to a webpage allowing the user to access the one or more relevant documents with one or more chunks of texts annotated with a visual indicator.

8. The method of claim 1, further comprising generating one or more follow-up questions to clarify the question and delivering the one or more follow-up questions to the user via the message interface.

9. The method of claim 1, further comprising generating a summary for each of the plurality of construction project documents.

10. The method of claim 1, wherein the plurality of construction specific documents comprise unstructured or semi-structured document text.

11. The method of claim 10, wherein the unstructured or semi-structured document text comprise at least an image, a table, a spreadsheet, or a combination thereof.

12. The method of claim 11, further comprising contextualizing the image, the table, or the spreadsheet based at least in part on metadata to generate a description for the image, the table, or the spreadsheet.

13. The method of claim 12, wherein the summary for each of the plurality of construction project documents and the description for the image, the table, or the spreadsheet is searchable.

14. The method of claim 13, wherein the one or more links are configured to link back to the summary or the description.

15. The method of claim 1, wherein the one or more links direct the user to an interface and wherein the interface displays the answer and a list of citations used to generate the answer.

16. The method of claim 15, wherein the list of citations comprise a list of source documents or a list of relevant passages or sections used to generate the answer.

17. The method of claim 1, further comprising highlighting the one or more relevant chunks from a linked relevant document used to answer the question.

18. The method of claim 17, wherein clicking on a section of the answer displays the one or more relevant chunks used to generate the section of the answer.

19. The method of claim 1, wherein the LLM prompt includes filenames of the plurality of construction project documents, the question, and a query instruction asking the LLM to select all documents that may be relevant to search for the answer to the user question.

20. A computer implemented system for generative question answering for construction project documents, the system comprising at least one processor, a memory, and instructions executable by the at least one processor to cause the at least one processor to perform:
(a) receiving a question from a user via a message interface, wherein the question is related to information from a plurality of construction project documents;
(b) generating a large language model (LLM) prompt based at least in part on the question;
(c) identifying, using one or more LLMs, one or more relevant documents from the plurality of construction project documents and one or more relevant chunks related to the question, and generating an answer based at least in part on the one or more relevant documents, the one or more relevant chunks, and the LLM prompt; and
(d) providing the answer and one or more links to the one or more relevant chunks used to generate the answer in a text message in the message interface.
